(19) United States
(12) Patent Application Publication
(10) Pub. No.: US 2007/0095801 A1
(43) Pub. Date: May 3, 2007

(54) LASER CUTTER DEVICE, PRINTING DEVICE WITH A LASER CUTTER, AND LASER PROCESSING METHOD

(75) Inventor: Masayoshi TODOROKIHARA, Suwa-shi, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/470,559

(22) Filed: Sep. 6, 2006

(30) Foreign Application Priority Data
Oct. 27, 2005 (JP) 2005-312304

(51) Int. Cl. B23K 26/00

(52) U.S. Cl. 219/121.6

(57) ABSTRACT

A laser cutter device includes a laser section irradiating a medium with laser light; and a laser carriage on which the laser section is mounted and reciprocating in a direction intersecting another direction in which the medium is conveyed. The laser section has a semiconductor laser element and processes the medium by irradiating the medium with the laser light condensed by correcting a wavefront of light emitted from the semiconductor laser element.

### BACKGROUND

1. Technical Field

The present invention relates to a laser cutter device that processes a medium made of paper, plastic, cloth, or other materials into a desired form, a printing device with a laser cutter that prints on a medium and processes the medium into a desired form by laser, and a laser processing method using the laser cutter device.

2. Related Art

JP-A-2003-535713 is an example of related art. As shown in FIG. 10, in a related art printing device with a laser cutter, a high-powered laser light is produced by condensing emitted light 95, with an optical system 94 mounted on a carriage 93, coming from a laser light source 92 that is located separately from a conveying mechanism conveying a medium 91 and a moving mechanism reciprocating the carriage 93. Then the medium 91 is processed by the laser light. The reason why the laser light source 92 is located separately from the conveying mechanism and the moving mechanism is that the laser light source 92 is so large and heavy that it is not suitable for being mounted on a moving mechanism such as the carriage 93.

Hubert Pages et. al., OPTICS EXPRESS, Vol. 13, No. 7, 2351 (2005) is another example of related art. A semiconductor laser element is used as a small and light laser light source, in contrast with the large and heavy laser light source 92. Since the semiconductor laser element has too small irradiation intensity to process a medium, a process using the semiconductor laser element is made possible by patterning an absorber on the medium in advance to raise its laser-light absorption rate.

In the related art device as mentioned above, the laser light source is so large and heavy that the laser light source and the optical system have to be located separately. Hence, it has been a problem that a device structure becomes complicated and device cost increases. On the method for using the small and light semiconductor laser element as mentioned above, it has been a problem that an operation of processing the medium needs extra effort because a processed part of the medium needs to be coated with an absorber.

### SUMMARY

An advantage of the present invention is to provide a laser cutter device that processes a sheet medium, a printing device with a laser cutter, and a method for laser processing, without increased device cost and taking much trouble in an operation.

A laser cutter device according to one aspect of the present invention includes a laser section irradiating a medium with laser light, and a laser carriage on which the laser section is mounted and which reciprocates in a direction intersecting another direction in which the medium is conveyed. The laser section has a semiconductor laser element and processes the medium by irradiating the medium with the laser light condensed by correcting a wavefront of light emitted from the semiconductor laser element.

In the laser cutter device according to the present aspect of the invention, the laser section mounted on the laser carriage produces laser light condensed by correcting a wavefront of light emitted from the semiconductor laser element and irradiates a medium with the laser light. Correcting the wavefront of light emitted from the semiconductor laser element enhances focusing characteristics. As a result, irradiation intensity of the condensed laser light is enhanced. Hence, it is possible to process a sheet medium without taking much trouble like applying an absorbent to a processed part. In addition, since the semiconductor laser element, which is smaller and lighter than related art laser light sources that cannot be mounted on a laser carriage, is mounted on the laser carriage, the device structure is simplified and substantial reduction in a device cost is achieved compared to devices using the related art laser sources.

In the laser cutter device according to the present aspect of the invention, the laser section may have a correcting member that corrects a wavefront of light emitted from the semiconductor laser element.

A printing device with a laser cutter according to another aspect of the invention includes a print head printing an image on a medium, a laser section irradiating the medium with laser light, a head carriage on which the print head is mounted and which reciprocates in a direction intersecting another direction in which the medium is conveyed, and a laser carriage on which the laser section is mounted and which reciprocates in the direction intersecting the other direction in which the medium is conveyed. The laser section has a semiconductor laser element and processes the medium by irradiating the medium with the laser light condensed by correcting a wavefront of light emitted from the semiconductor laser element.

In the printing device with a laser cutter according to the present aspect of the invention, the print head mounted on the head carriage prints an image on a medium and the laser section mounted on the laser carriage produces laser light condensed by correcting a wavefront of light emitted from the semiconductor laser element and irradiates the medium with laser light. Correcting the wavefront of light emitted from the semiconductor laser element enhances focusing characteristics. As a result, irradiation intensity of the condensed laser light is enhanced. Hence, it is possible to process the printed medium along an outline and the like of the printed image without taking much trouble like applying an absorbent to a processed part. Moreover, since the semiconductor laser element, which is smaller and lighter than the related art laser light sources that cannot be mounted on a laser carriage, is mounted on the laser carriage, the device structure is simplified and substantial reduction in a device cost is achieved compared to devices using the related art laser sources.

In the printing device with a laser cutter according to the present aspect of the invention, a whole image on the medium may be processed to be cut out.

In the printing device with a laser cutter according to the present aspect of the invention, the medium may be processed to be provided with a perforated line.

The laser cutter device according to the present aspect of the invention, the laser section may have a correcting member that corrects a wavefront of light emitted from the semiconductor laser element.

In the printing device with a laser cutter according to the present aspect of the invention, the head carriage and the laser carriage may be built in one.

In the printing device with a laser cutter according to the present aspect of the invention, the head carriage and the laser carriage may be built separately.

A printing device with a laser cutter according to still another aspect of the invention includes a print head printing an image on a sheet medium, a laser section irradiating the sheet medium with laser light, a head carriage on which the print head is mounted and which reciprocates in a direction intersecting another direction in which the sheet medium is conveyed, and a laser carriage on which the laser section is mounted and which reciprocates in the direction intersecting the other direction in which the sheet medium is conveyed. The laser section has a first sub laser section located to face one side of the sheet medium and a second sub laser section located to face the other side of the sheet medium. The first sub laser section irradiates a part to be a line for a mountain fold specified in the image with the laser light so as to process the medium for the mountain fold. The second sub laser section irradiates a part to be a line for a valley fold specified in the image with the laser light so as to process the medium for the valley fold.

In the printing device with a laser cutter according to the present aspect of the invention, the print head mounted on the head carriage prints an image on a sheet medium. The first sub laser section mounted on the laser carriage while facing one side of the medium irradiates a part to be a line for a mountain fold specified in the image with the laser light condensed by correcting a wavefront of light emitted from a semiconductor laser element to process the medium for the mountain fold. The second sub laser section facing the other side of the medium irradiates another part to be a line for a valley fold specified in the image with the laser light to process the medium for the valley fold. Correcting the wavefront of light emitted from the semiconductor laser element enhances focusing characteristics of the laser light, and thereby enhancing irradiation intensity. Therefore, it is possible to process the medium to mountain fold and valley fold it easily without taking much trouble like applying an absorbent to a processed part. Moreover, since the semiconductor laser element, which is smaller and lighter than related art laser light sources that cannot be mounted on a laser carriage, is mounted on the laser carriage, the device structure is simplified and substantial reduction in a device cost is achieved compared to devices using the related art laser sources.

A method for laser processing according to still another aspect of the invention includes: reciprocating a laser carriage on which a laser section that irradiates a medium with laser light is mounted in a direction intersecting another direction in which the medium is conveyed, and processing the medium by irradiating the medium with the laser light condensed by correcting a wavefront of light emitted from a semiconductor laser element included in the laser section.

### BRIEF DESCRIPTION OF THE DRAWINGS

The invention will be described with reference to the accompanying drawings, wherein like numbers reference like elements.

FIG. 1 is a schematic perspective view showing an example of a cutter printer according to a first embodiment.

FIG. 2 is a schematic perspective view of a head.

FIG. 3 is a schematic view of a laser part.

FIG. 4 is a block diagram showing the electrical structure of a cutter printer.

FIG. 5 is a flowchart showing an operation, after an operation of printing an image on a sheet, of processing the sheet.

FIG. 6 is an overview drawing showing an example of a cutter printer according to a second embodiment.

FIG. 7 is a flowchart showing operations, after printing an image on a sheet, of processing a folding line in the image and cutting the sheet.

FIGS. 8A to 8C illustrate operations of processing folding lines and cutting. FIG. 8A shows an example of a box built from a cut out paper pattern. FIG. 8B shows a sheet before printed. FIG. 8C shows a printed image on the sheet.

FIGS. 9A to 9C illustrate operations of printing, processing a folding line, and cutting. FIG. 9A shows the image with lines for mountain folds processed. FIG. 9B shows the rear face of the sheet with lines for valley folds in the image processed. FIG. 9C shows the paper pattern that has been cut out.

FIG. 10 is a schematic view showing an example of a related art printing device with a laser cutter.

### DESCRIPTION OF EXEMPLARY EMBODIMENTS

First Embodiment

A printing device with a laser cutter (herein after referred to as “cutter printer”) according to a first embodiment of the invention will now be described with reference to the accompanying drawings. The cutter printer described below corresponds to the laser cutter device according to one aspect of the invention, except for the description of printing below.

Structure of Cutter Printer

First, the structure of the cutter printer will be described.

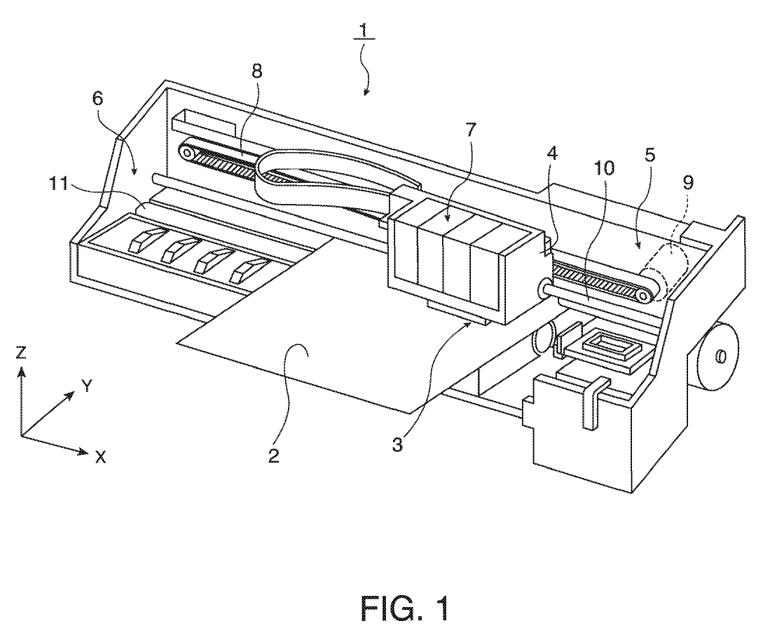

FIG. 1 is a schematic perspective view that shows an example of the cutter printer according to the first embodiment. As shown in FIG. 1, this cutter printer 1 includes a head 3, an ink cartridge 7, a carriage 4 to which the head 3 and the ink cartridge 7 are mounted, a carriage moving section 5 having a timing belt 8 and a carriage motor 9, a sheet conveying section 6 having a platen roller 11, for example, and a guide rod 10.

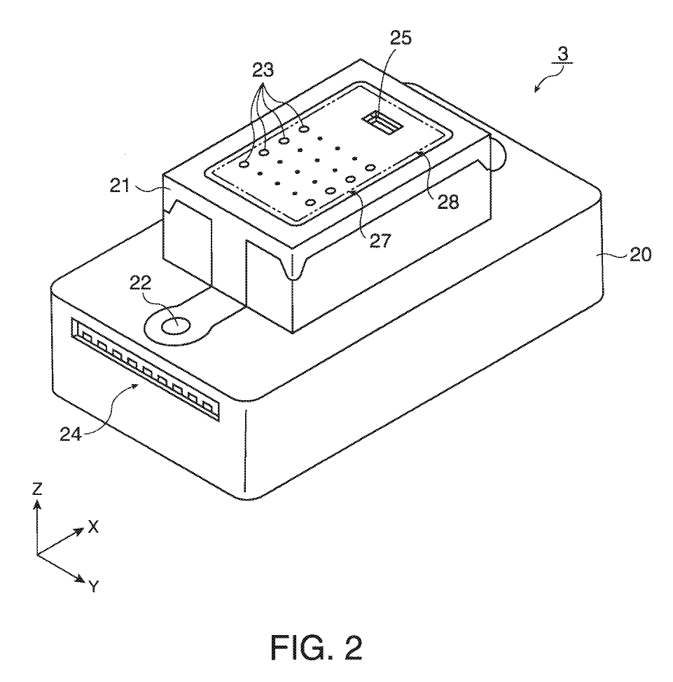

The head 3 has a print head 27 (referred to FIG. 2) ejecting ink and printing an image on a front face of a sheet 2 as a sheet medium, and also has a laser cutter 28 (referred to FIG. 2) processing the sheet 2 along an outline and the like of a printed image. The sheet conveying section 6 conveys the sheet 2 back and forth in the y-axis direction in the drawing. The carriage moving section 5 drives the timing belt 8 by rotary-driving the carriage motor 9 such as a DC motor. Accordingly, the carriage 4 reciprocates along the guide rod 10 in a direction intersecting another direction in which the sheet 2 is conveyed (i.e., in the x-axis direction) along the guide rod 10.

Structure of Head

Next, the structure of the head is described referring to FIG. 2.

FIG. 2. is a schematic perspective view of the head. As shown in FIG. 2, the head 3 has, as an appearance, a base member 20 made of hard resin or the like, the print head 27 having a nozzle opening 23, the laser cutter 28 lying next to the print head 27 and having a laser section 25, a cover member 21, a rivet 22 and a connecting terminal part 24.

The print head 27 faces the front face of the sheet 2 and ejects ink suitably from the nozzle opening 23 while reciprocating in the x-axis direction so as to make ink droplets landed to desired positions of the sheet 2 and form a printing image. The laser cutter 28 faces the front face of the sheet 2 and irradiates laser light from the laser section 25 with reciprocating in the x-axis direction so as to process a desired position of the sheet 2. The rivet 22 is used to attach the cover member 21 to the base member 20. The connecting terminal part 24 provides an electrical connection with a printer body through a flexible cable. The back side of the head 3 (not shown) is provided with an ink introducing section (not shown) to which the ink cartridge 7 supplies ink.

Structure of Laser Unit

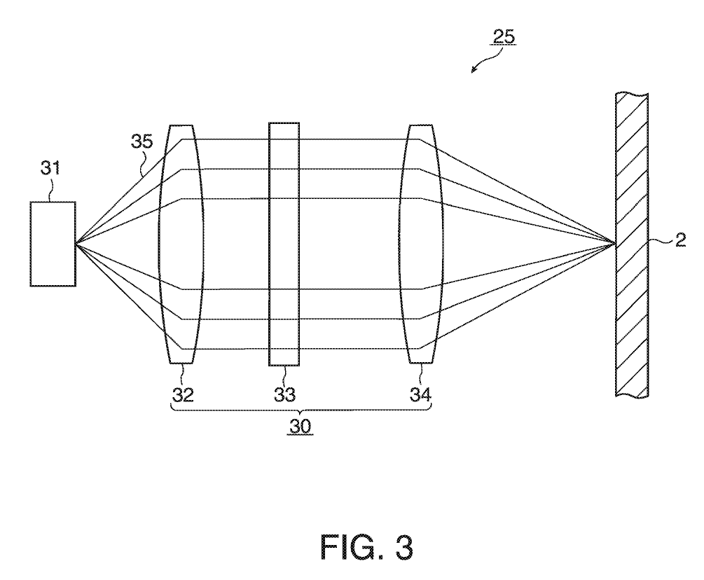

The structure of the laser section is described referring to FIG. 3.

FIG. 3 is a schematic view of the laser unit. As shown in FIG.3, the laser section 25 has a semiconductor laser element 31 and has, as an optical element 30, a collimating lens 32, a correcting plate 33 as a correcting member, and a condenser lens 34.

As the semiconductor laser element 31, a semiconductor laser element that performs single mode oscillation is used so that a minute focused spot is provided. Laser light 35 as light emitted from the semiconductor laser element 31 is collimated by the collimating lens 32. The wavefront of the collimated laser light 35 is corrected while it passes through the correcting plate 33 so that condensing performance improves. The laser light 35 that has passed through the correcting plate 33 is condensed by the condenser lens 34, thereby making a processed spot on the sheet 2.

The semiconductor laser element 31 has superior characteristics such as a reduction in size and weight, a longer operating life, a stable performance and a high energy efficiency. While the laser light 35 passes through the correcting plate 33, the laser light 35 is corrected to have a high condensing performance with wavefront aberration that shows wavefront distortion restrained. Here, the spot diameter of the laser light 35 condensed by the condenser lens 34 is refined to a minimal level, so that a medium made of paper, vinyl, cloth, or other materials can be processed.

Electrical Structure of Cutter Printer

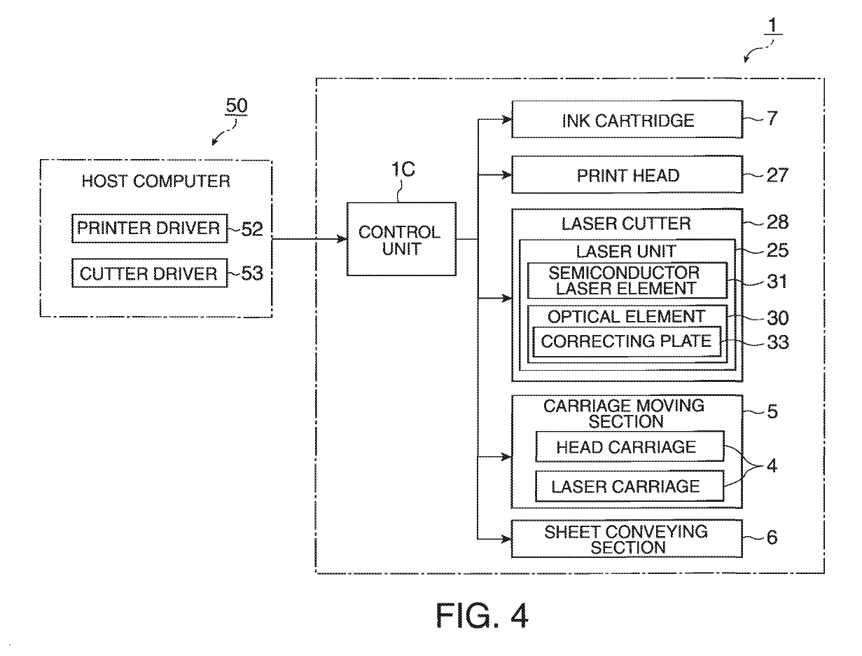

The electrical structure of the cutter printer is described referring to FIG. 4.

FIG. 4 is a block diagram showing the electrical structure of the cutter printer. As shown in FIG. 4, the cutter printer 1 includes a control unit 1C, the ink cartridge 7, the print head 27, the laser cutter 28, the carriage moving section 5, and the sheet conveying section 6. The laser cutter 28 has the laser section 25. The laser section 25 has the semiconductor laser element 31 and the optical element 30 including the correcting plate 33 as a correcting member. The carriage moving section 5 has the carriage 4 in which a head carriage and a laser carriage are built in one.

A host computer 50 has a printer driver 52 that is software controlling a printing operation and also has a cutter driver 53 that is software controlling a processing operation.

In a printing operation to the sheet 2, the control unit 1C receives printing data to operate printing from the printer driver 52 in the host computer 50 and operates printing by controlling the ink cartridge 7, the print head 27, the carriage moving section 5, the sheet conveying section 6 and the rest, based on the received data. In a processing operation on the sheet 2, the control unit 1C receives a processing data to operate processing from the cutter driver 53 in the host computer 50 and operates processing by controlling the laser cutter 28, the carriage moving section 5, the sheet conveying section 6, and the rest, based on the received data.

Printing and Processing Operation

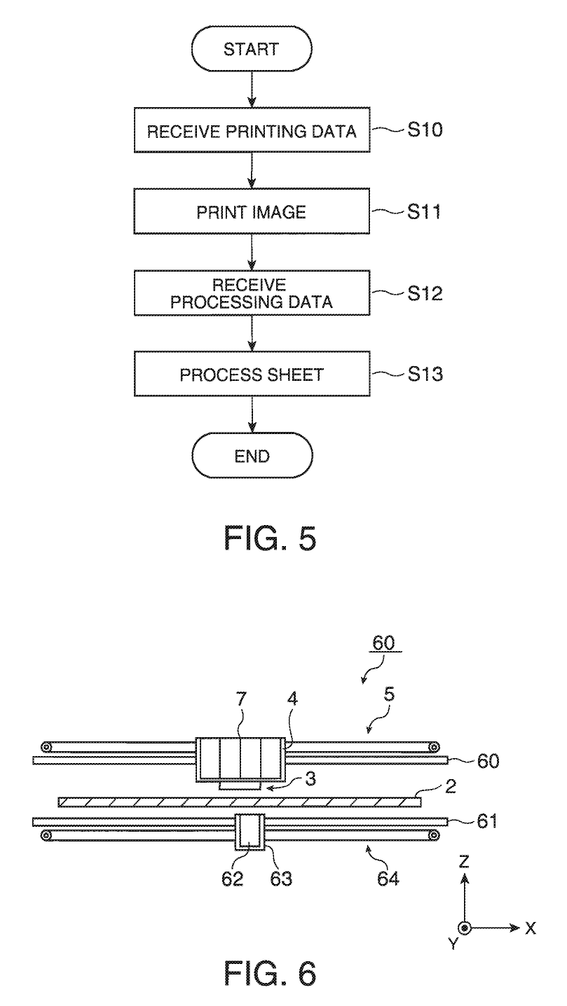

Next, an operation, after an operation of printing an image on a sheet, of processing the sheet is described referring to FIG. 5.

FIG. 5 is a flowchart showing an operation, after an operation of printing an image on a sheet, of processing the sheet.

First, in Step S10, the control unit 1C receives printing data from the printer driver 52 in the host computer 50. The printing data includes commands controlling each of the ink cartridge 7, the print head 27, the carriage moving section 5. the sheet conveying section 6, and the rest as well as data of an object to be printed.

In Step S11, the control unit 1C analyzes contents of commands included in the printing data, controls each aforementioned section related to printing, and prints an image on the sheet 2. Specifically, the sheet conveying section 6 feeds the sheet 2 to the inside of the cutter printer 1 to a print starting position, at first. Next, as the carriage moving section 5 reciprocates the carriage 4 in the x-axis direction, the print head 27 mounted on the carriage 4 ejects ink intermittently, As the sheet conveying section 6 conveys the sheet 2 forward in the y-axis direction, an image is formed on the sheet 2 with a plurality of dots.

In Step S12, the control unit 1C receives processing data from the cutter driver 53 in the host computer 50. The processing data includes commands controlling each of the laser cutter 28, the carriage moving section 5, the sheet conveying section 6, and the rest as well as vector data presenting a processed shape in vector form. Vector data presenting a shape of an outline and the like of the image to be processed, for example, may be made by transforming the printing data used in the printing operation of the image.

In Step S13, the control unit 1C analyzes the vector data and contents of commands included in the processing data, controls each aforementioned section related to processing, and processes the sheet 2 based on the vector data. In case that the image printed on the sheet 2 is cut out, the sheet 2 is cut based on the abovementioned vector data. Specifically, the sheet conveying section 6 conveys backward the sheet 2, which was conveyed forward in the y-axis direction in the Step 11, to a cut starting position, at first. Next, the image printed on the sheet 2 is cut along the outline and the like in turn by controlling the carriage moving section 5 reciprocating the laser cutter 28 in the x-axis direction, the sheet conveying section 6 conveying the sheet 2 back and forth in the y-axis direction, and the laser section 25 attached to the laser cutter 28 emitting laser light, based on the vector data to cut out the image out of the sheet 2. To provide a perforated line of the image printed on the sheet 2 instead of being cut out, a laser light irradiation condition is controlled to make perforations.

Reciprocating a laser carriage in a direction intersecting another direction in which a medium is conveyed according to one aspect of the invention corresponds to the operation of making the laser cutter 28 reciprocate in the x-axis direction by the carriage moving section 5 in Step S13. Moreover, processing the medium by irradiating it with laser light corresponds to the operation of processing the sheet 2 by irradiating it with laser light from the laser section 25 in Step S13.

As mentioned above, on the cutter printer 1 in the first embodiment, the carriage 4 reciprocating in the x-axis direction is provided with the print head 27 that prints an image and the laser cutter 28 that processes the sheet 2. The laser cutter 28 processes the sheet 2 by irradiating it with laser light 35 condensed while passing from the semiconductor laser element 31 through the correcting plate 33. When the laser light 35 whose light source is the semiconductor laser element 31 passes through the correcting plate 33 to be condensed, irradiation intensity is enhanced, thereby enabling the laser light 35 to be used for processing. In addition, the semiconductor laser element 31 is small and light, and the optical element 30 for enhancing the irradiation intensity has a simple device structure that does not need a complicated device structure, so that it is achieved to mount the laser cutter 28 onto the carriage 4. Also, it is an advantage that the laser cutter 28 can take the same controlling method as the print head 27 that prints an image because the print head 27 and the laser cutter 28 are built in one and mounted onto the carriage 4.

Second Embodiment

A cutter printer according to a second embodiment of the present invention will be described with reference to the accompanying drawings.

Structure of Cutter Printer According to the Second Embodiment

First, the structure of a cutter printer according to the second embodiment is described.

FIG. 6 is an overview drawing that shows an example of the cutter printer according to the second embodiment. As FIG. 6 shows, this cutter printer 60 is different from the cutter printer 1 of the first embodiment illustrated in FIG. 1 in that the cutter printer 60 has a laser cutter 62 as a second sub laser section located under the sheet 2, a carriage 63 to which a laser cutter 62 is mounted, a carriage moving section 64, and a guide rod 61.

The head 3 located above the front face of the sheet 2 shown in FIG. 6 has the same structure as the head 3 illustrated in FIG. 2. Specifically, the head 3 is provided with the print head 27 and the laser cutter 28 as a first sub laser section, the carriage 4 reciprocates along the guide rod 10 in the x-axis direction by drive of the carriage moving section 5, and the laser cutter 28 mounted on the carriage 4 irradiates the front face of the sheet 2 with laser light.

The carriage 63 located below the sheet 2 reciprocates along the guide rod 61 in the x-axis direction by drive of the carriage moving section 64 in the same manner as the carriage 4. The laser cutter 62 mounted on the carriage 63 irradiates the rear face of the sheet 2 with laser light while moving.

Operations of Printing, Processing and Cutting According to the Second Embodiment

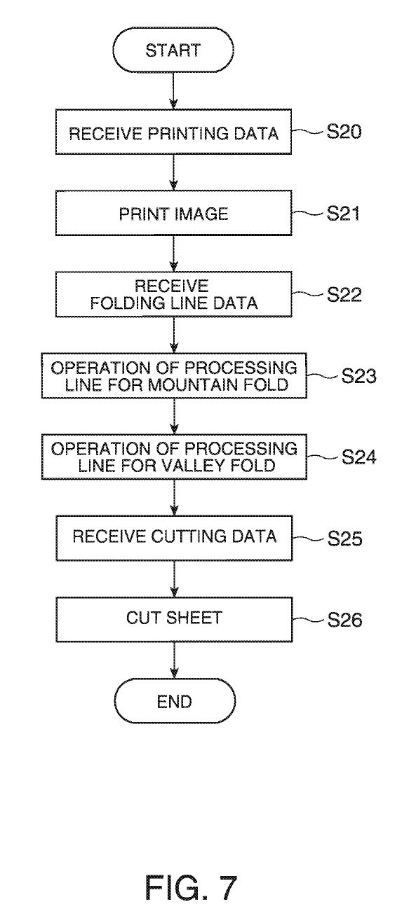

Next, operations, after an operation of printing an image on a sheet, of processing folding lines in the image and cutting the sheet are described with reference to FIGS. 7, 8A to 8C, and 9A to 9C.

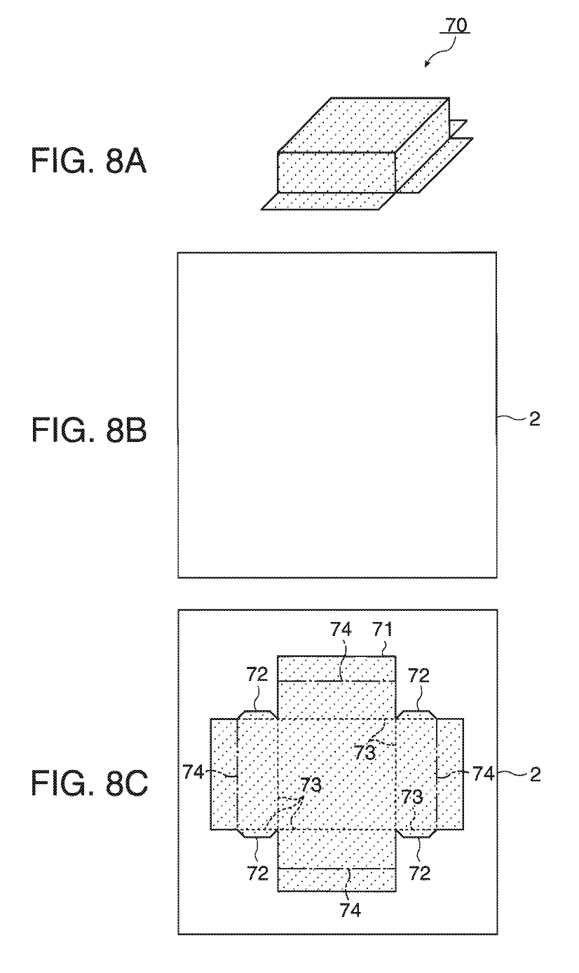

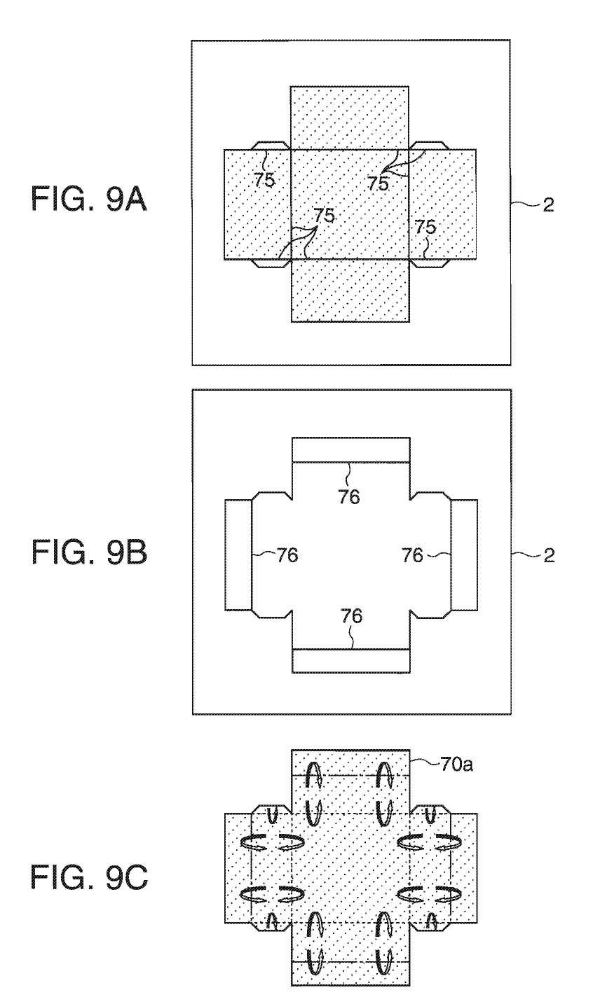

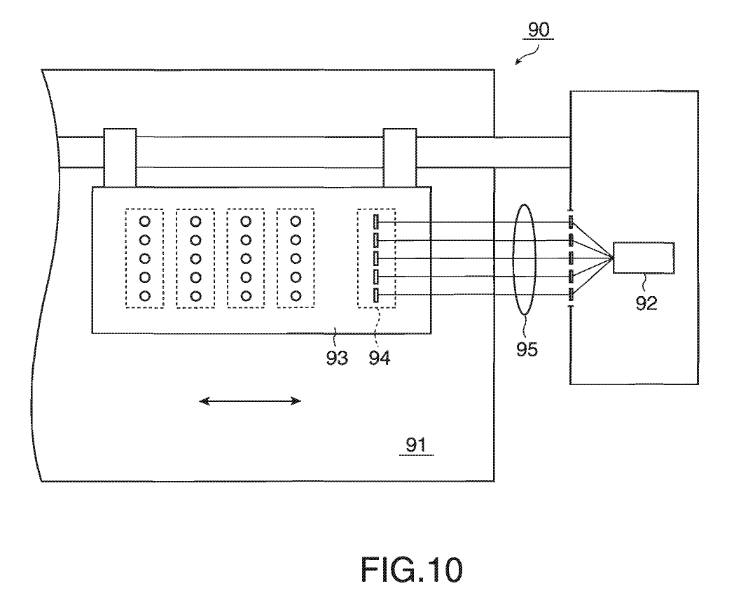

FIG. 7 is a flowchart showing operations, after an operation of printing an image on a sheet, of processing folding lines in the image and cutting the sheet. FIGS. 8A to 8C and 9A to 9C illustrate operations of printing, processing a folding line and cutting. FIG. 8A illustrates a box built from a paper pattern that has been cut out, FIG. 8B shows a sheet before printed, and FIG. 8C shows an image printed on the sheet. FIG. 9A shows the printed image with lines for mountain folds processed, FIG. 9B shows the rear face of the sheet with lines for valley folds in the image processed, and FIG. 9C shows the paper pattern that has been cut out. The paper pattern to make the box shown in FIG. 8A is formed by each operation from S20 through S26 shown in FIG. 7.

In Steps S20 and S21 shown in the flowchart of FIG. 7, as in Steps S10 and S11 shown in the flowchart of FIG. 5, the controlling unit 1C receives printing data from the printer driver 52 in the host computer 50, controls each section related to printing, and prints an image on the sheet 2. In the example of FIGS. 8A to 8C, the blank sheet shown in FIG. 8B is set in the cutter printer 60 and the image shown in FIG. 8C is printed by operations of Steps S20 and S21. FIG. 8C shows in the image a cutting line 71 as a solid line of the outline of the image along which it is cut out, lines 73 for mountain folds as short dashed lines along which the paper pattern is mountain folded, and lines 74 for valley folds as dotted and dashed lines along which the paper pattern is valley folded. The drawing also shows glued parts 72.

In Step S22, the control unit 1C receives fold line data from the cutter driver 53 in the host computer 50. The fold line data includes the followings: vector data that represents forms of the lines 73 for mountain folds and the lines 74 for valley folds shown in FIG. 8C in vector form, and commands of discriminating between lines for mountain folds and lines for valley folds and of controlling the laser cutters 28 and 62, the carriage moving sections 5 and 64, the sheet conveying section 6, and the rest, which process the fold lines.

In Step S23, the controlling unit 1C analyzes the vector data and contents of commands included in the fold line data and controls each of the laser cutter 28 located above the sheet 2, the carriage moving section 5, the sheet conveying section 6, and the rest. Accordingly, the front face of the sheet 2 is irradiated with laser light along the lines 73 for mountain folds of the printed image to process the front face of the sheet 2 to have notches. In the operations above, the amount of the irradiated laser light is made just large enough to notch the front face of the sheet 2 by at least one of the following: reducing the amount of the irradiated laser light, or accelerating a scanning speed of the laser light on the sheet 2. In FIG. 9A, the front face of the sheet 2 is irradiated with laser light to process the lines 73 for mountain folds, thereby making notching lines 75.

In Step S24, as the case of Step S23, the controlling unit 1C analyzes the vector data and contents of commands included in the fold line data and controls each of the laser cutter 62, the carriage moving section 64, the sheet conveying section 6, and the rest located under the sheet 2. Accordingly, the rear face of the sheet 2 is irradiated with laser light along lines that correspond to the lines 74 for valley folds in the image printed on the front face of the sheet 2 to process the rear face of the sheet 2 to have notches. In this case as well, like the case of Step S23, the amount of the irradiated laser light is reduced to be just large enough to make notches on the rear face of the sheet 2. FIG. 9B shows the rear face of the sheet 2. Notching lines 76 are made as a result of irradiating the rear face of the sheet 2 with laser light and processing the lines that correspond to the lines 74 for valley folds.

In Steps S25 and S26, as in Steps S12 and S13 shown in the flowchart in FIG. 5, the controlling unit 1C receives cutting data from the cutter driver 53 in the host computer 50 to cut the sheet 2 along the cutting line 71 of the printed image, thereby cutting out a paper pattern. In this case, the amount of irradiated laser light is made just large enough to cut the sheet 2. FIG. 9C shows this paper pattern 70A cut out of the sheet 2. Folding directions along the lines for mountain folds and folding directions along the lines for valley folds are shown by the arrows while they are not printed in the image. The paper pattern 70A is folded as the arrows indicate and the glued parts 72 are applied with an adhesive such as a glue, and bonded with corresponding parts. Then the box 70 shown in FIG. 8A is built up. In addition, it is possible to process the adhesive-applied sides of the glued parts 72 with laser light in advance. For example, adhesive strength is enhanced by irradiating surfaces of the glued parts 72 with laser light to make them rough.

As mentioned above, in the cutter printer 60 of the second embodiment, the print head 27, the laser cutter 28, the carriage moving section 5, and the rest are located to face the front face of the sheet 2. The laser cutter 62, the carriage conveying section 64, and the rest are located to face the rear face of the sheet 2. By irradiating the front face of the sheet 2 with laser light whose amount is made small along the lines 73 for mountain folds, the paper pattern 70A is provided with notches on the front face that makes it easy to mountain fold the paper pattern 70A. In addition, by irradiating the rear face of the sheet 2 with laser light whose amount is made small along lines on the rear face corresponding to the lines 74 for valley folds, the paper pattern 70A is provided with notches on the rear face that makes it easy to valley fold the paper pattern 70A. Hence, folding the paper pattern 70A along the lines 73 for mountain folds and the lines 74 for valley folds becomes easier and operating efficiency needed to build up a box for example improves significantly. Moreover, a series of operations for making a paper pattern is achieved by involving printing an image of the paper pattern on a sheet, making notches along lines for mountain folds and lines for valley folds in the image through laser light irradiation, and cutting out the paper pattern. Hence, the Invention has various applications, including manufacturing a paper pattern of a model made of paper such as a paper craft.

First Modification

The same advantageous effect as described above can be achieved by separately providing and controlling the head carriage section on which the head 27 is mounted and the laser carriage section on which the laser cutter 28 is mounted and reciprocating them in the x-axis direction instead of building them in one like in the aforementioned embodiments. In this case, cost rising to add the cutter function is restrained compared to the devices in the embodiments, because the cutter function may be added to a printing mechanism such as a related art print head.

Second Modification

In the aforementioned. embodiments, the laser cutter 28 is provided with one laser section 25 but it is not limited to that. The laser cutter 28 may be provided with two laser cutters. Specifically, on the head 3 shown in FIG. 2, in addition to the laser part 25 provided on the right side of the print head 27 in FIG. 2, some space to provide another laser section can be reserved on the left side of the print head 27 and a second laser section can be provided there. Providing laser sections on the both sides of the print head 27 makes it possible to use both of the right laser section and the left laser section for irradiation at the same time and nearly halve the time for processing when a symmetrical figure is processed, for example.

Third Modification

While in the aforementioned embodiments, the invention is applied to an ink jet printer, it is applicable to serial printers such as dot printers and, thermal printers. Moreover, by providing a laser cutter mechanism and a carriage moving mechanism on which the laser cutter mechanism is mounted to a separate location from a printing mechanism, the invention may be applied to page printers and line printers.

What is claimed is:

1. A laser cutter device, comprising;
a laser section irradiating a medium with laser light; and
a laser carriage on which the laser section is mounted and reciprocating in a direction intersecting another direction in which the medium is conveyed;
wherein the laser section has a semiconductor laser element and processes the medium by irradiating the medium with the laser light condensed by correcting a wavefront of light emitted from the semiconductor laser element.

2. The laser cutter device according to claim 1, wherein the laser section has a correcting member, the correcting member correcting a wavefront of light emitted from the semiconductor laser element.

3. A printing device with a laser cutter, comprising;
a print head printing an image on a medium;
a laser section irradiating the medium with laser light;
a head carriage on which the print head is mounted and reciprocating in a direction intersecting another direction in which the medium is conveyed; and
a laser carriage on which the laser section is mounted and reciprocating in the direction intersecting the other direction in which the medium is conveyed;
wherein the laser section has a semiconductor laser element and processes the medium by irradiating the medium with the laser light condensed by correcting a wavefront of light emitted from the semiconductor laser element.

4. The printing device with a laser cutter according to claim 3, wherein a whole image on the medium is processed to be cut out.

5. The printing device with a laser cutter according to claim 3, wherein the medium is processed to be provided with a perforated line.

6. The printing device with a laser cutter according to claim 3, wherein the laser section has a correcting member, the correcting member correcting a wavefront of light emitted from the semiconductor laser element.

7. The printing device with a laser cutter according to claim 3, wherein the head carriage and the laser carriage are built in one.

8. The printing device with a laser cutter according to claim 3, wherein the head carriage and the laser carriage are built separately.

9. A printing device with a laser cutter, comprising;
a print head printing an image on a sheet medium;
a laser section irradiating the sheet medium with laser light;
a head carriage on which the print head is mounted and reciprocating in a direction intersecting another direction in which the sheet medium is conveyed; and
a laser carriage on which the laser section is mounted and reciprocating in the direction intersecting the other direction in which the sheet medium is conveyed;
wherein the laser section has a first sub laser section located to face one side of the sheet medium and a second sub laser section located to face the other side of the sheet medium;
the first sub laser section irradiates a part to be a line for a mountain fold specified in the image with the laser light so as to process the medium for the mountain fold; and
the second sub laser section irradiates another part to be a line for a valley fold specified in the image with the laser light so as to process the medium for the valley fold.

10. A method for laser processing, comprising:
reciprocating a laser carriage on which a laser section that irradiates a medium with laser light is mounted in a direction intersecting another direction in which the medium is conveyed; and
processing the medium by irradiating the medium with the laser light condensed by correcting a wavefront of light emitted from a semiconductor laser element included in the laser section.
